(19) United States
(12) Patent Application Publication
(10) Pub. No.: US 2026/0259111 A1
(43) Pub. Date: Sep. 3, 2026

(54) ASSEMBLY FOR A STEERING DEVICE

(71) Applicant: ZF FRIEDRICHSHAFEN AG, Friedrichshafen (DE)

(72) Inventor: Ingo BECKER, Linnich (DE)

(21) Appl. No.: 18/716,956

(22) PCT Filed: Dec. 8, 2022
(86) PCT No.: PCT/EP2022/084951

§ 371 Date: Jun. 6, 2024

(30) Foreign Application Priority Data
Dec. 10, 2021 (DE) 10 2021 214 126.9

(51) Int. Cl. G01M 17/007

(52) U.S. Cl. CPC G01M 17/007

(57) ABSTRACT

An assembly (2) for a steering device (1), the assembly (2) having an input shaft (3) and an output shaft (4) and a torsion mechanism (5) coupling the input shaft (3) to the output shaft (4), and the torsion mechanism (5) being designed in the form of a torsion spring element (6, 7), more particularly a spiral spring or helical spring, or comprises such a spring.

### TECHNICAL FIELD

The invention relates to an assembly for a steering device, said assembly having an input shaft and an output shaft and a torsion mechanism that couples the input shaft to the output shaft.

### BACKGROUND

Steering devices for motor vehicles, which steering devices have above-described assemblies comprising an input shaft, an output shaft and a torsion device, are known in principle from the prior art. Such steering devices are intended in particular to allow the determination of a torque applied by a driver to a steering element that is coupled to the input shaft. The input shaft can thus be rotated relative to the output shaft, with a torsion element being deformed. The deformation of the torsion element, for example through a particular angle, can subsequently be used as a basis for determining the torque.

This necessitates that the input shaft is positioned exactly relative to the output shaft when the assembly is assembled. Since the input shaft is coupled via the torsion element to the output shaft, it is thus necessary to precisely measure the alignments of the individual components in order to be able to center these. Here, it is also necessary that the measured and set centering is not lost when the components are coupled to one another.

It is furthermore known that the input shaft and the output shaft cannot be arbitrarily rotated relative to one another, because this is blocked, for example by mechanical means. Since the relative rotatability between the input shaft and output shaft is blocked, it is firstly achieved that the steering capability of the motor vehicle is maintained if a fault occurs, for example in the event of a breakage of the torsion element, and it is furthermore ensured that the torsion element can be deformed only in a particular angle range. Nevertheless, damage to the torsion element, for example to a torsion bar, cannot be ruled out during the operation of the assembly.

For example, a torsion bar is pressed into the output shaft, and the input shaft is subsequently pushed over the torsion bar. The preassembled assembly must subsequently be measured and aligned such that the exact orientation between the input shaft and the output shaft can be established. Here, even small deviations in either of the two directions of rotation must be avoided. The described assembly method therefore requires sophisticated equipment for measuring the assembly and for precisely aligning the parts relative to one another. Furthermore, carrying out the measurement and centering is cumbersome and time-consuming, and the achievable precision has potential for improvement. There is also no mechanical redundancy, in particular in the event of damage to the torsion element.

The invention is based on the object of specifying an assembly, which is improved in relation to this, for a steering device.

### SUMMARY

The object is achieved by a method having the features of claim 1. The subclaims relate to advantageous refinements.

As described, the invention relates to an assembly for a steering device, said assembly having an input shaft and an output shaft, wherein at least one torsion mechanism couples the input shaft to the output shaft. In other words, a rotational movement that is applied to the input shaft is transmitted via the torsion mechanism to the output shaft. The invention is based on the recognition that the torsion mechanism is designed as or comprises a torsion spring element, in particular a spiral spring or helical spring. In other words, the invention proposes that, in a described assembly, a conventionally used torsion bar be omitted. Through the use of torsion spring elements or of at least one torsion spring element, the structural length required in an axial direction in relation to the axis of rotation of the input shaft and of the output shaft can be considerably reduced. In terms of its production and assembly, the at least one torsion spring element itself is not subject to any precise requirements such as have been described above with regard to the torsion bar.

In particular, no elaborate installation process is required, because the torsion spring element can ultimately be arranged arbitrarily on the input shaft and output shaft as long as it is achieved that, in the event of a rotational movement between the input shaft and output shaft, the torsion spring element builds up a spring force or a torque that couples the input shaft and output shaft to one another. In particular, no pressing-in, drilling, calking or other elaborate installation method is required. Ultimately, the input shaft and output shaft remain supported relative to one another, in particular by means of a bearing device, wherein the torsion spring element merely performs the coupling of the two components. Furthermore, the effort involved in alignment or centering, measurement and the like is reduced, because such method steps are eliminated owing to the omission of the torsion bar.

The centering of the input shaft relative to the output shaft is implemented directly during the assembly process by way of the geometrical arrangement of the spiral spring(s) relative to the shafts. Elaborate measurement of the centering is eliminated.

In one refinement of the assembly, provision may be made for the torsion mechanism to have at least two torsion spring elements, which are arranged in particular in different axial positions. In principle, the assembly may provide for the torsion mechanism to be arranged on the output shaft or on the input shaft and to produce a mechanical connection to the input shaft or to the output shaft. Descriptions given below which are based on one of the two alternatives, for example an arrangement of the torsion mechanism on the input shaft and a support on the output shaft, are consequently transferable to the other alternative in each case. For example, in the corresponding descriptions, the terms “input shaft” and “output shaft” are interchangeable.

The arrangement or the use of at least two torsion spring elements offers the advantage that mechanical redundancy is created. If one of the two torsion spring elements is damaged, in particular destroyed, then at least one further torsion spring element remains in order to couple the input shaft of the output shaft. This allows the steering device to remain steerable even if one of the torsion spring elements of the assembly fails. Here, it is possible in principle to provide any desired number of torsion spring elements, which are arranged in particular in different axial positions. As already described, the axial direction is understood to mean the direction of the axis of rotation of the assembly, that is to say in particular the coinciding axes of rotation of the output shaft and of the input shaft. The axial direction may also be understood as the central axis or axis of symmetry of the assembly.

The mechanical redundancy that is achieved through the provision of at least two torsion spring elements means that, in the event of failure of one torsion spring element, for example in the event of breakage of one torsion spring element, the torque can nevertheless be transmitted from the input shaft the output shaft by the remaining torsion spring element. Here, the user of the motor vehicle is provided with mechanical feedback, because there is an abrupt change in the behavior of the steering device. The defect in the steering device can thus be identified, and remedied for example upon the next visit to a workshop.

The assembly may furthermore be refined in that at least two torsion spring elements are of identical or different design and/or at least two torsion spring elements are oriented identically or differently in relation to a circumferential direction about a longitudinal axis of the assembly. The longitudinal axis of the assembly may in particular coincide with the axial direction or axis of rotation as described above. In the described refinement, it is possible in principle to use at least two identical torsion spring elements. For example, each of the torsion spring elements may have the same spring stiffness, such that, ultimately, the torque is transmitted between the input shaft and output shaft via each of the torsion spring elements equally. If one of the torsion spring elements fails, all of the torque is accordingly transmitted via the remaining torsion spring elements.

It is likewise possible for at least two of the torsion spring elements that are used to be of different design. The differences in the design of the torsion spring elements may relate in principle to any mechanical parameters of the torsion spring elements. In particular, the different torsion spring elements may be selected to have different spring stiffnesses. This makes it possible, for example, for one torsion spring element to be of softer or stiffer design than the at least one other torsion spring element. For example, a spring stiffness of one torsion spring element may be lower than that of the other torsion spring element. If one of the torsion spring elements fails, the steering capability can continue to be ensured by means of the other torsion spring element. The mechanical feedback to the user of the motor vehicle can thus be targetedly defined through suitable selection of the torsion spring elements.

Provision may likewise be made for the alignment and/or connection of the torsion spring elements to differ. For example, the individual torsion spring elements may be arranged differently in the circumferential direction in the assembly. For example, support points on the input shaft or on the output shaft may be provided at different circumferential positions. If exactly two torsion spring elements are used, it is possible for their abutment points, support points and/or drivers by which the torsion spring elements are attached to the input shaft or output shaft to be arranged at opposite circumferential positions or so as to be spaced apart by 180° in the circumferential direction.

In a further refinement of the assembly, provision may be made for one torsion spring element to be designed as a main torsion spring element and for one torsion spring element to be designed as a fall-back torsion spring element. A targeted distribution of functions among the individual components can thus be achieved. In particular, mechanical redundancy can be ensured, with the torque being transmitted between the input shaft and the output shaft primarily by the main torsion spring element. In the event of a defect in the main torsion spring element, the torsion spring element designed as a fall-back torsion spring element can be used to transmit the torque between the input shaft and output shaft. The main torsion spring element and fall-back torsion spring element may in particular have different ranges of action and/or different spring stiffnesses. For example, the fall-back torsion spring element may be employed only when the main torsion spring element has already been deflected through a certain angle range.

In a further refinement of the assembly, a detection device may be provided which is designed to detect a defect in at least one torsion spring element. As described above, it is possible in principle for the user, when operating the steering device, to identify that at least one of the torsion spring elements is damaged, for example broken. The detection device makes it possible to objectively detect the steering capability of the steering device. For example, steering movements that are performed by a user of the motor vehicle using the steering device may be detected. If the steering behavior of the user suddenly changes, in particular with regard to the torques or steering angles applied, the detection device may output a warning. Since, as described above, mechanical redundancy is preferably achieved through the provision of at least two torsion spring elements, the detection device may in this case suggest that a visit be made to a workshop, for example by virtue of a particular output being displayed to the user of the motor vehicle. It is likewise possible for a warning message to be output, which indicates to the user that the steering device is impaired.

As described above, use may be made of at least two torsion spring elements that are of different design. In one refinement of the assembly, one torsion spring element may be designed as a sacrificial torsion spring element, in particular owing to a weakening of the torsion spring element. The sacrificial torsion spring element may for example be of relatively thin form, in terms of the material used, at at least one point on the component. It is likewise possible for the sacrificial torsion spring element to be formed from a different material in at least one portion. In general, it is also possible for a predetermined breaking point to be provided in the sacrificial torsion spring element, which has the effect that the sacrificial torsion spring element is damaged or breaks significantly prior to the at least one further torsion spring element.

The at least one further torsion spring element may advantageously be primarily responsible for transmitting the torque between the input shaft and output shaft, such that the steering capability is maintained virtually unchanged in the event of a failure of the sacrificial torsion spring element. In this case, the user can nevertheless identify, albeit to a greatly reduced degree, that the steering behavior of the steering device has changed, such that a visit can be made to a workshop. The detection device described above can subjectively identify that the sacrificial torsion spring element has been damaged, for example broken, and can initiate the corresponding outputs or measures as described above.

As already described, the torsion mechanism may have at least one first driver element, which is arranged on the input shaft and couples a torsion spring element to the input shaft, and/or at least one second driver element, which is arranged on the output shaft and couples the torsion spring element to the output shaft. The driver element thus implements a mechanical coupling of the torsion spring element to the input shaft and/or to the output shaft. The driver elements are for example designed as splints which project in an axial direction, and may drive protruding terminations or ends, for example legs, of the torsion spring elements in the event of a rotational movement between the input shaft and output shaft.

Any desired arrangement of the individual driver elements is also possible in principle, wherein the arrangement of the driver elements preferably corresponds, in a basic state, to the alignment of the terminations of the torsion spring elements or of the at least one torsion spring element. A basic state is understood in particular to mean a state of the steering device in which the input shaft has not been rotated relative to the output shaft, or the angle between the input shaft and output shaft is 0°, for example during straight-ahead travel.

In a further refinement of the assembly, provision may be made for at least one first driver element arranged on the input shaft to be designed as a groove and/or for at least one second driver element arranged on the output shaft to be designed as a splint that protrudes in an axial direction. The groove may extend in the axial direction within the input shaft or the output shaft. As already described, the descriptions are transferable to the reversed alternatives, which means in particular that the terms “input shaft” and “output shaft” are interchangeable.

The torsion spring elements that are used may in particular have a geometry corresponding thereto. For example, the torsion spring elements have at least one engagement portion that can be introduced into the groove, for example when the torsion spring elements are pushed in an axial direction onto the input shaft and/or output shaft. In this case, the torsion spring elements engage with at least one loop or winding around the input shaft or the output shaft, with the engagement portions being received in the groove.

The invention furthermore relates to a steering device for a motor vehicle, said steering device having an assembly as described above. The invention furthermore relates to a method for assembling an assembly for a steering device, in particular an assembly as described above, wherein the input shaft is coupled to the output shaft, in particular by means of a bearing device, and subsequently at least one torsion element designed as a torsion spring element is mounted onto the input shaft or the output shaft, wherein the torsion spring element, in the installed position, couples the input shaft to the output shaft.

As described, the at least one torsion spring element may, in order to be installed, be pushed in an axial direction onto the input shaft or the output shaft, wherein one part of the torsion spring element provides a coupling to the input shaft and one part of the torsion spring element provides a coupling to the output shaft, for example through the use of at least one driver element. It is thus ensured that the torsion spring element cannot be rotated relative to the input shaft and the output shaft, but instead, in the event of a relative rotation between the input shaft and output shaft, imparts a torque that is directed so as to return the input shaft and output shaft into their basic position.

All advantages, details and features that have been described with reference to the assembly are transferable in their entirety to the steering device and the method.

### BRIEF DESCRIPTION OF DRAWINGS

The invention will be discussed below on the basis of exemplary embodiments and with reference to the figures. The figures are schematic illustrations and show the following:

FIG. 1 a detail of a steering device for a motor vehicle in a longitudinal sectional illustration;

FIG. 2 a detail of a steering device for a motor vehicle in a cross-sectional illustration;

FIG. 3 a torsion spring element of an assembly for a steering device according to FIGS. 1 and 2;

FIGS. 4a-4d a detail of a steering device for a motor vehicle in a longitudinal sectional illustration in different states of assembly; and

FIGS. 5a-5c a detail of a steering device for a motor vehicle in a cross-sectional illustration in different exemplary embodiments.

### DESCRIPTION

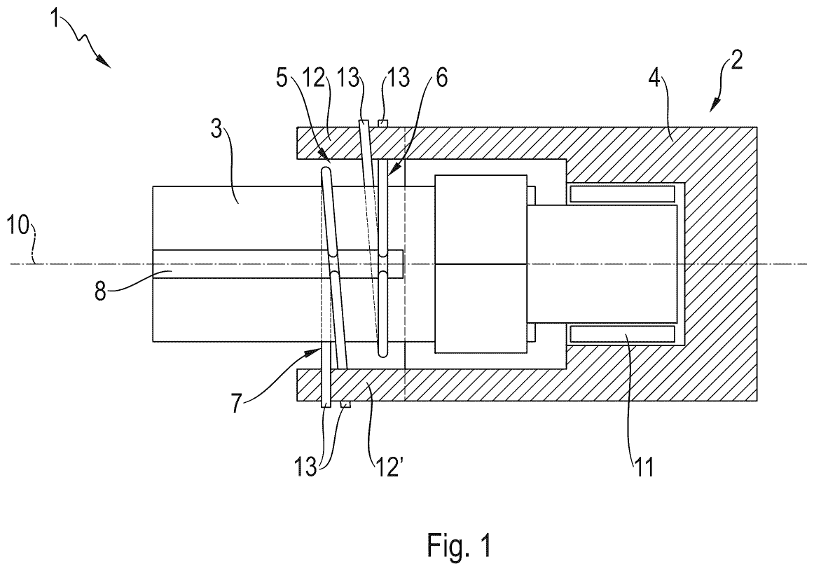

FIG. 1 shows a detail of a steering device 1 for a motor vehicle (not illustrated in any more detail). The steering device 1 comprises an assembly 2 that has an input shaft 3, an output shaft 4 and a torsion mechanism 5. In principle, the coupling configuration determines the function of the input shaft 3 and of the output shaft 4, that is to say the manner in which these are arranged in a torque flow between an operator control element, for example a steering wheel, and a steering gear of the motor vehicle. The description that follows is therefore entirely reversible. In particular, the terms “input shaft” and “output shaft” are interchangeable.

The input shaft 3 is supported on, and rotatable relative to, the output shaft 4 by means of a bearing device 11, for example a radial bearing, and a torque applied to the input shaft 3 can be transmitted to the output shaft 4, specifically via the torsion mechanism 5, which couples the input shaft 3 to the output shaft 4. In the embodiment shown, the torsion mechanism 5 has two torsion spring elements 6, 7, wherein refinements are also possible in which only one torsion spring element 6, 7 or any desired further number of torsion spring elements 6, 7 is or are provided.

The torsion spring elements 6, 7 are attached both to the input shaft 3 and to an output shaft 4 such that said torsion spring elements cannot rotate relative to the input shaft 3 and output shaft 4. Instead, the torsion spring elements 6, 7 are supported on both components and impart a restoring torque in the event of a rotation between the input shaft 3 and output shaft 4. The torsion spring elements 6, 7 are arranged in different axial positions in relation to an axis of rotation 10 of the steering device 1 or of the assembly 2. The axis of rotation 10 may also be referred to as an axis of symmetry or be understood as the axis of rotation 10 of the input shaft 3 or of the output shaft 4.

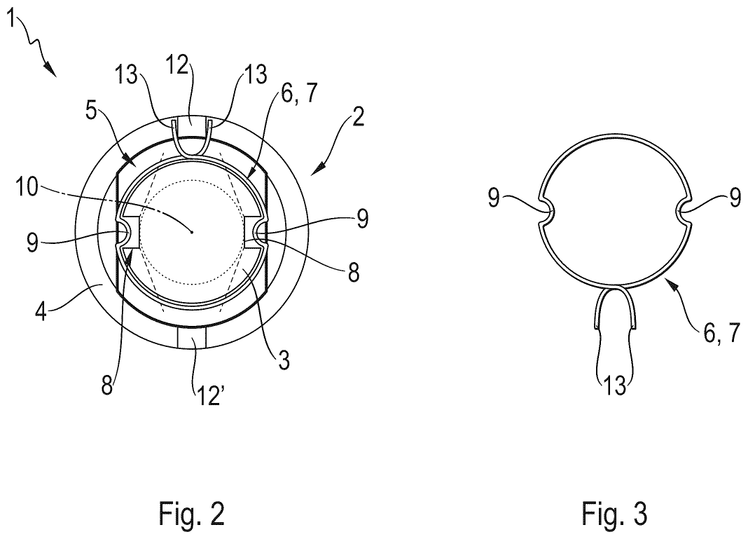

In the refinement shown, the input shaft 3 has, as illustrated in FIG. 2, two grooves 8 into which engagement portions 9 of the torsion spring elements 6, 7 engage. As can be seen most clearly in FIGS. 2 and 3, the engagement portions 9 of the torsion spring elements 6, 7 engage radially into the grooves 8 on the input shaft 3, such that the torsion spring elements 6, 7 are not rotatable relative to the input shaft 3. Furthermore, the output shaft 4 has driver elements 12, 12′ on which the torsion spring elements 6, 7 are supported. During a rotational movement of the input shaft 3 and/or of the output shaft 4, a deformation of the torsion spring elements 6, 7 occurs because these are driven by the engagement portions 9 in the grooves 8 in the input shaft 3 and by the driver elements 12, 12′, or in each case by one driver element 12, 12′, of the output shaft 4.

FIG. 3 illustrates a torsion spring element 6, 7 in isolation. As can be seen, the engagement portions 9 extend radially inward at oppositely situated circumferential positions, which engagement portions, during the assembly process, engage into the grooves 8 that extend in the axial direction along the axis of rotation 10. FIG. 3 also illustrates terminations 13 of the torsion spring element 6, 7, by means of which the torsion spring element 6, 7 bears against the driver element 12, 12′ of the output shaft 4.

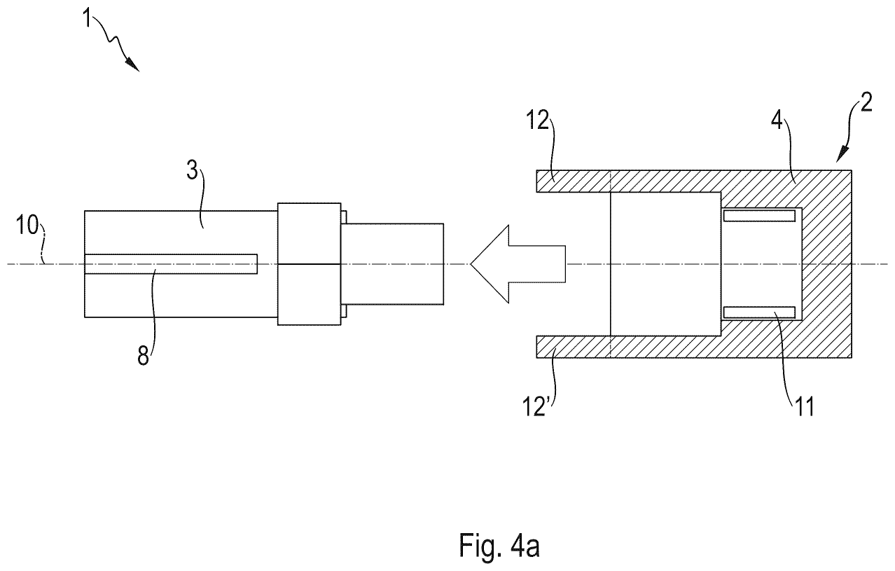

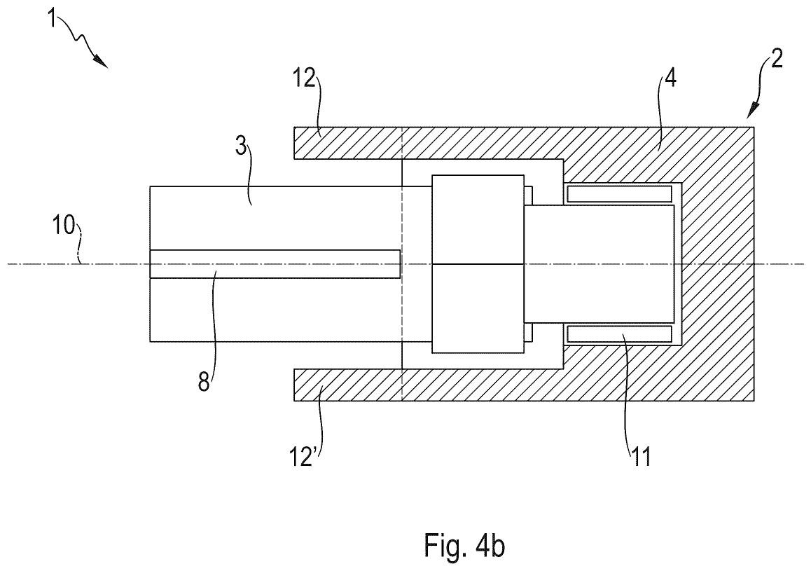

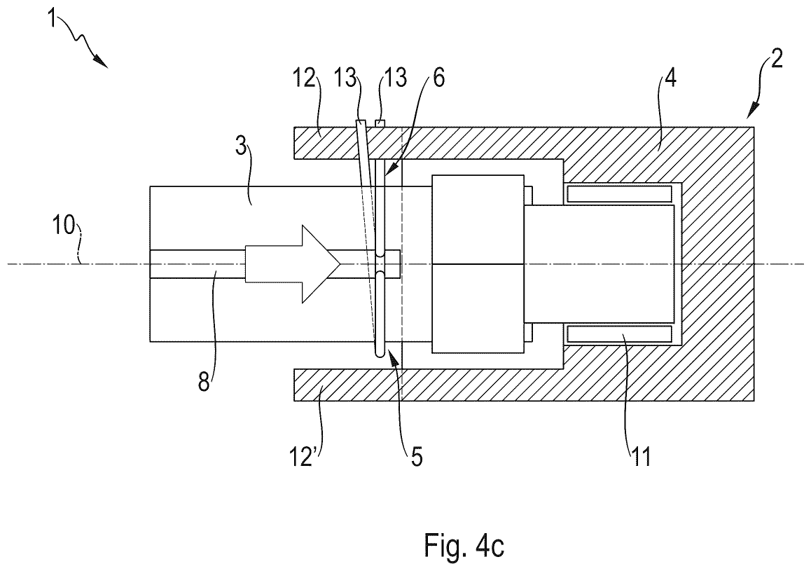

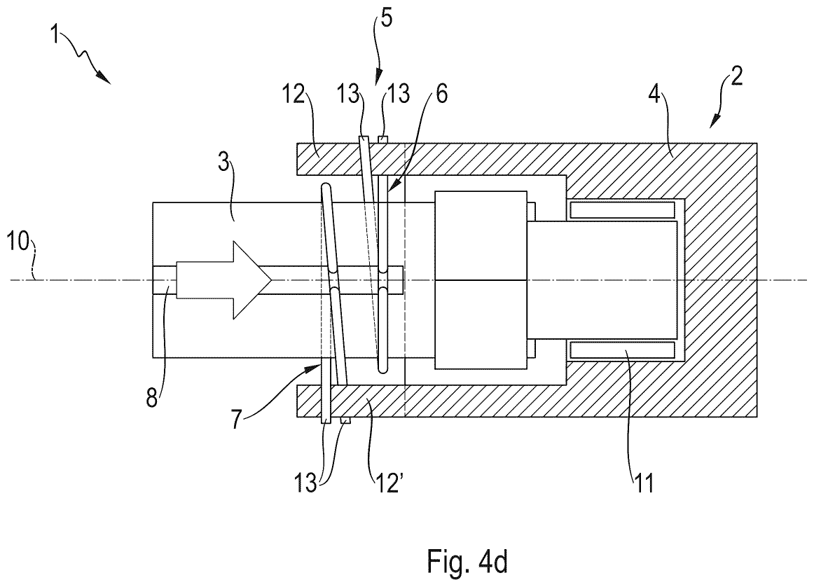

FIGS. 4a-4d illustrate, by way of example, a process of assembling the assembly 2. FIG. 4a illustrates that the input shaft 3 can be joined to the output shaft 4. In particular, a portion of the input shaft 3 can be introduced into the bearing device 11 in the output shaft 4, so as to be able to proceed from the situation illustrated in FIG. 4a into the situation illustrated in FIG. 4b, or the illustrated assembled state. Proceeding from the state in FIG. 4b, at least one of the torsion spring elements 6, 7 can be pushed in the axial direction onto the input shaft 3 and the output shaft 4. In the process, as described above, the engagement portions 9 of the torsion spring element 6 engage into the grooves 8 in the input shaft 3, and the terminations 13 are placed in contact with the driver element 12 of the output shaft 4.

FIG. 4d illustrates that at least one second torsion spring element 7 can be pushed in the axial direction onto the input shaft 3 and the output shaft 4. This subsequently yields the fully assembled assembly 2, illustrated in FIG. 1, for the steering device 1. As can be seen, no elaborate centering, alignment and measurement are necessary during the assembly process. Compared with torsion bars such as are conventionally used in the prior art, the production and use of torsion spring elements 6, 7 are not subject to any precise configuration. The dimensional accuracy or the manufacturing and arrangement of the torsion spring elements 6, 7 have no influence on the positioning or the positioning accuracy between the input shaft 3 and output shaft 4.

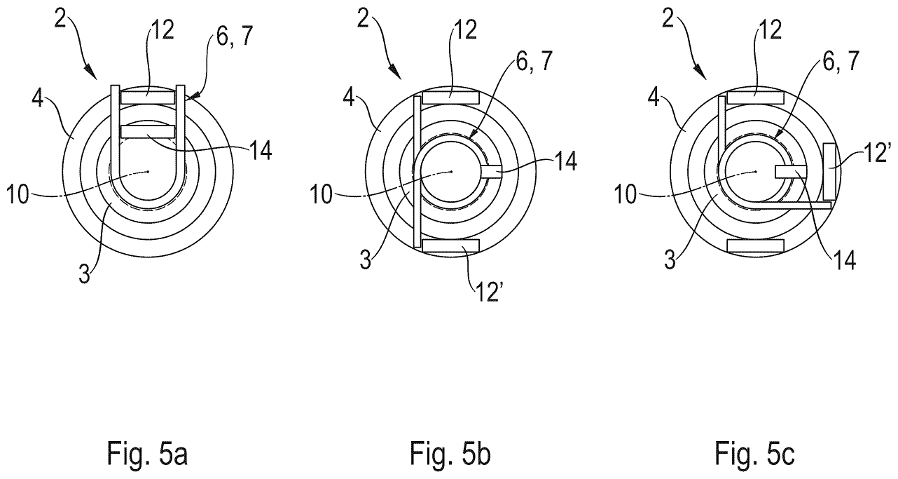

FIGS. 5a-5c illustrate three different exemplary embodiments relating to the arrangement of the torsion spring elements 6, 7 and their driver elements 12, 12′, 14. In FIG. 5a, the input shaft 3 has a driver element 14, and the output shaft 4 has in each case one driver element 12. The illustrated torsion spring element 6, 7 is U-shaped or clip-shaped in the illustrated cross section, wherein it is in turn possible for more than one torsion spring element 6, 7 to be used. Depending on the direction of the deflection between the input shaft 3 and output shaft 4, the torsion spring element 6, 7 is deformed by the driver elements 12, 14.

FIG. 5b illustrates a looped torsion spring element 6, 7, in the case of which the torsion spring element 6, 7, for example a main body in wire form, has at least one winding. In the exemplary embodiment shown, the torsion spring element 6, 7 is fixedly attached via a driver element 14 to the input shaft 3. The output shaft 4 has two driver elements 12, 12′, against which the terminations 13 of the torsion spring element 6, 7 bear. Accordingly, the torsion spring element 6, 7 builds up a torque in the event of a relative rotation between the input shaft 3 and output shaft 4.

FIG. 5c shows a further exemplary embodiment, which corresponds in principle to the exemplary embodiment in FIG. 5b. In the illustration shown, the directions of the terminations 13 and the arrangement of the driver elements 12, 12′ on the output shaft 4 have been changed. Whilst FIG. 5b shows an arrangement of the terminations 13 and of the driver elements 12, 12′ in which these are each spaced apart by 180° or situated opposite one another in the circumferential direction, the terminations 13 of the torsion spring element 6, 7 in FIG. 5 c are spaced apart by 90°. Likewise, the driver elements 12, 12′ are arranged on the output shaft 4 at an angle of 90° in the circumferential direction. The exemplary embodiments shown in FIGS. 5a-5c are to be understood merely as examples. Any desired arrangement of the terminations 13 and of the driver elements 12, 12′, 14 is possible in principle.

Although the torsion spring elements 6, 7 are illustrated in the individual exemplary embodiments as being identical, use may be made of identical or different torsion spring elements 6, 7. The torsion spring elements 6, 7 may differ in particular with regard to their mechanical characteristics.

The above description of the steering device 1 is transferable in its entirety to the method described above. The details and features are likewise transferable to a motor vehicle that has the steering device 1. All advantages, details and features that have been described with reference to the individual exemplary embodiments are, in their entirety, combinable with one another, interchangeable with one another and transferable to one another.

### REFERENCE DESIGNATIONS

1 Steering device
2 Assembly
3 Input shaft
4 Output shaft
5 Torsion mechanism
6,7 Torsion spring element
8 Groove
9 Engagement portion
10 Axis of rotation
11 Bearing device
12, 12′ Driver element
13 Termination
14 Driver element

1. An assembly (2) for a steering device (1), which assembly (2) has an input shaft (3) and an output shaft (4) and a torsion mechanism (5) that couples the input shaft (3) to the output shaft (4), wherein the torsion mechanism (5) is designed as or comprises a torsion spring element (6, 7), in particular a spiral spring or helical spring.

2. The assembly (2) as claimed in claim 1, wherein the torsion mechanism (5) has at least two torsion spring elements (6, 7), which are arranged in particular in different axial positions.

3. The assembly (2) as claimed in claim 2, wherein at least two torsion spring elements (6, 7) are of identical or different design and/or at least two torsion spring elements (6, 7) are oriented identically or differently in relation to a circumferential direction about a longitudinal axis of the assembly (2).

4. The assembly (2) as claimed in claim 2, wherein one torsion spring element (6, 7) is designed as a main torsion spring element, and one torsion spring element (6, 7) is designed as a fall-back torsion spring element.

5. The assembly (2) as claimed in claim 1, wherein a detection device that is designed to detect a defect in at least one torsion spring element (6, 7).

6. The assembly (2) as claimed in claim 1, wherein one torsion spring element (6, 7) is designed as a sacrificial torsion spring element, in particular owing to a weakening of the torsion spring element (6, 7).

7. The assembly (2) as claimed in claim 1, wherein the torsion mechanism (5) has at least one first driver element (12, 12′, 14), which is arranged on the input shaft (3) and couples a torsion spring element (6, 7) to the input shaft (3), and/or at least one second driver element (12, 12′, 14), which is arranged on the output shaft (4) and couples the torsion spring element (6, 7) to the output shaft (4).

8. The assembly (2) as claimed in claim 1, wherein at least one first driver element (12, 12′, 14) arranged on the input shaft (3) is designed as a groove (8) and/or at least one second driver element (12, 14) arranged on the output shaft (4) is designed as a splint that protrudes in an axial direction.

9. A steering device (1) for a motor vehicle, comprising an assembly (2) as claimed in claim 1.

10. A method for assembling an assembly (2) for a steering device (1), in particular an assembly (2) as claimed in claim 1, wherein the input shaft (3) is coupled to the output shaft (4), and subsequently at least one torsion element designed as a torsion spring element (6, 7) is mounted onto the input shaft (3) or the output shaft (4), wherein the torsion spring element (6, 7), in the installed position, couples the input shaft (3) to the output shaft (4).
